(19) United States
(12) Patent Application Publication
(10) Pub. No.: US 2020/0366571 A1
(43) Pub. Date: Nov. 19, 2020

(54) DISPLAYING A SERVICE GRAPH OF MICROSERVICES BASED AT LEAST ON A NAMESPACE

(71) Applicant: Citrix Systems, Inc., Fort Lauderdale, FL (US)

(72) Inventors: Chiradeep Vittal, Santa Clara, CA (US); Lawrence Shorter, Santa Clara, CA (US); Kapil Jaisinghani, Santa Clara, CA (US); Sonny Chhen, Santa Clara, CA (US)

(21) Appl. No.: 16/415,157

(22) Filed: May 17, 2019

(51) Int. Cl. H04L 12/24

(52) U.S. Cl. CPC H04L 41/5032

(57) ABSTRACT

Described embodiments provide systems and methods for displaying a service graph of microservices based at least on a namespace. A device establishes a namespace of a plurality of namespaces for each of a plurality of microservices of one or more services. The device receives a request to display a service graph of the plurality of microservices corresponding to a selected namespace of the plurality of namespaces. The device generates the service graph comprising one or more of the microservices associated with the selected namespace. The device displays the service graph for the selected namespace.

### FIELD OF THE DISCLOSURE

The present application generally relates to service graphs, including but not limited to systems and methods for displaying a service graph of a plurality of microservices.

### BACKGROUND

Various services may be used, accessed, or otherwise provided to users. Such services may include microservices which perform a subset of tasks or functions which, collectively, provide the service to the user. Various microservices may be deployed under different conditions, at different locations, handle different amounts of traffic, etc.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed to grouping microservices into namespaces for generating service graphs of particular sets of microservices. A service graph may be a tool by which a service including various microservices corresponding thereto may be visualized. Such a tool may be used for network traffic monitoring purposes, diagnostic purposes, troubleshooting purposes, and so forth. The service graph may depict various metrics corresponding to network conditions and topology (e.g., traffic volume, latency, error rates, and other metrics corresponding to the service). In some implementations, a user may want to view certain microservices of a given service. For instance, the user may want to monitor certain subsets of microservices at a given time.

A device can establish namespaces associated with subsets of the microservices. Each namespace may be associated with a subset of microservices of various service(s). The namespaces may be user-generated, generated by the device based on network traffic flow, etc. The namespaces may be organized by the functions that the respective microservices provide, by a hierarchy of the microservices, a geography or location in which the microservices are deployed, and so forth. A user can request (e.g., on the user's device) displaying of a service graph of microservices corresponding to a selected namespace. The device can generate and display the service graph including the microservices corresponding to the selected namespace. Thus, microservices can be compartmentalized and organized into namespaces for easy selection and display. The user can toggle between namespaces by providing corresponding inputs on the user interface. The device can correspondingly display a service graph on the user interface.

According to one aspect, this disclosure is directed to a method for displaying a service graph of microservices based at least on a namespace. The method includes establishing, by a device, a namespace of a plurality of namespaces for each of a plurality of microservices of one or more services. The method includes receiving, by the device, a request to display a service graph of the plurality of microservices corresponding to a selected namespace of the plurality of namespaces. The method includes generating by the device, the service graph comprising one or more of the microservices associated with the selected namespace. The method includes displaying, by the device, the service graph for the selected namespace.

In some embodiments, establishing the namespace includes configuring a tag of a microservice to identify one or more namespaces of the microservice. In some embodiments, the namespace includes one of a geography or a location at which a microservice is deployed. In some embodiments, the namespace includes one of a function or functionality implemented by a microservice. In some embodiments, the namespace includes an identifier for a logical groups of two or more of the plurality of microservices. In some embodiments, the namespace includes an identifier for a layer of a plurality of layers in a hierarchy of layers for the one or more services.

In some embodiments, receiving the request includes receiving, by the device via a user interface, a selection of the namespace from the plurality of the namespaces. In some embodiments, the method further includes receiving a request to change the selected namespace to a second namespace and redisplaying the service graph based at least on the second namespace. In some embodiments, the method further includes receiving a request to display the service graph with a resolution from a plurality of resolutions. Each of the plurality of resolutions may include a corresponding level of detail. The method may further include displaying, by the device, the service graph based at least on the resolution.

According to another aspect, this disclosure is directed to a system for displaying a service graph of microservices based at least on a namespace. The system includes a device comprising one or more processors, coupled to memory. The device is configured to establish a namespace of a plurality of namespaces or each of a plurality of microservices of one or more services. The device is configured to receive a request to display a service graph of the plurality of microservices corresponding to a selected namespace of the plurality of namespaces. The device is configured to generate the service graph comprising one or more of the microservices associated with the selected namespace. The device is configured to display the service graph for the selected namespace.

In some embodiments, a tag of a microservice is configured to identify one or more namespaces of the microservice. In some embodiments, the namespace includes one of a geography or a location at which a microservice is deployed. In some embodiments, the namespace includes one of a function or functionality implemented by a microservice. In some embodiments, the namespace includes an identifier for a logical groups of two or more of the plurality of microservices. In some embodiments, the namespace includes an identifier for a layer of a plurality of layers in a hierarchy of layers for the one or more services.

In some embodiments, the device is configured to receive a selection of the namespace from the plurality of the namespaces. In some embodiments, the device is configured to receive a request to change the selected namespace to a second namespace and redisplaying the service graph based at least on the second namespace. In some embodiments, the device is further configured to receive a request to display the service graph with a resolution from a plurality of resolutions. Each of the plurality of resolutions may include a corresponding level of detail. In some embodiments, the device is further configured to display the service graph based at least on the resolution.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5A is a block diagram of a service graph based system, in accordance with an illustrative embodiment;

FIG. 5B is a block diagram of a service graph, in accordance with an illustrative embodiment;

FIG. 5C is a flow diagram of a method of using a service graph, in accordance with an illustrative embodiment;

FIG. 6A is an example user interface including a service graph, in accordance with an illustrative embodiment;

FIG. 6B-FIG. 6D are example user interfaces of a service graph of microservices based on namespaces, in accordance with an illustrative embodiment; and

FIG. 6E is a flow diagram of a method for displaying a service graph of microservices based on namespaces, in accordance with an illustrative embodiment.

### DETAILED DESCRIPTION

For purposes of reading the description of the various embodiments below, the following descriptions of the sections of the specification and their respective contents may be helpful:

Section A describes a network environment and computing environment which may be useful for practicing embodiments described herein;

Section B describes embodiments of systems and methods for delivering a computing environment to a remote user;

Section C describes embodiments of systems and methods for virtualizing an application delivery controller;

Section D describes embodiments of systems and methods for providing a clustered appliance architecture environment;

Section E describes embodiments of a service graph based platform and technology; and

Section F describes embodiments of systems and methods for displaying a service graph of microservices based on namespaces.

### A. A. Network and Computing Environment

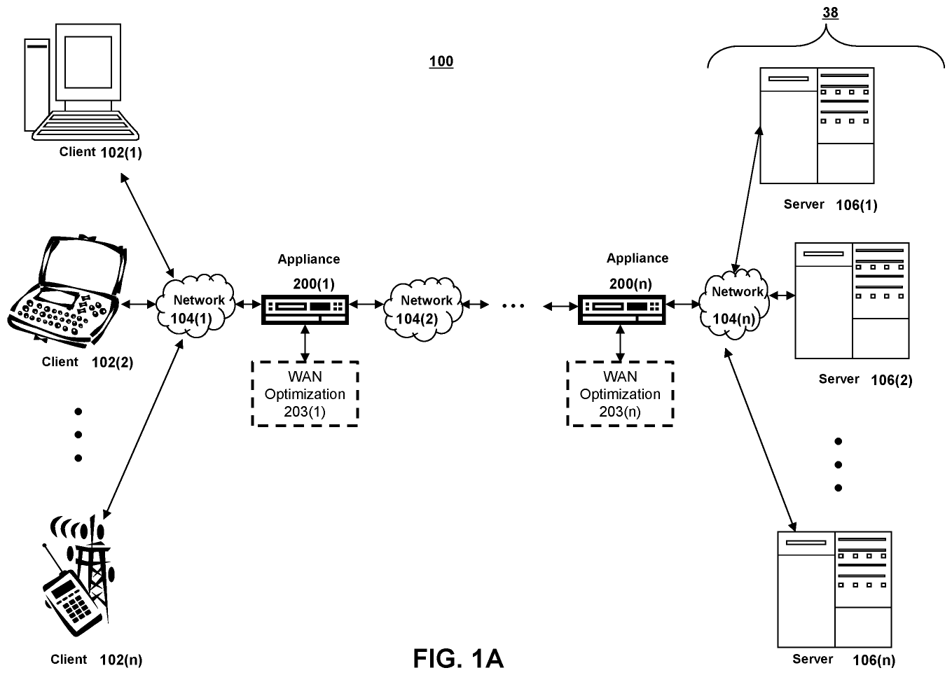

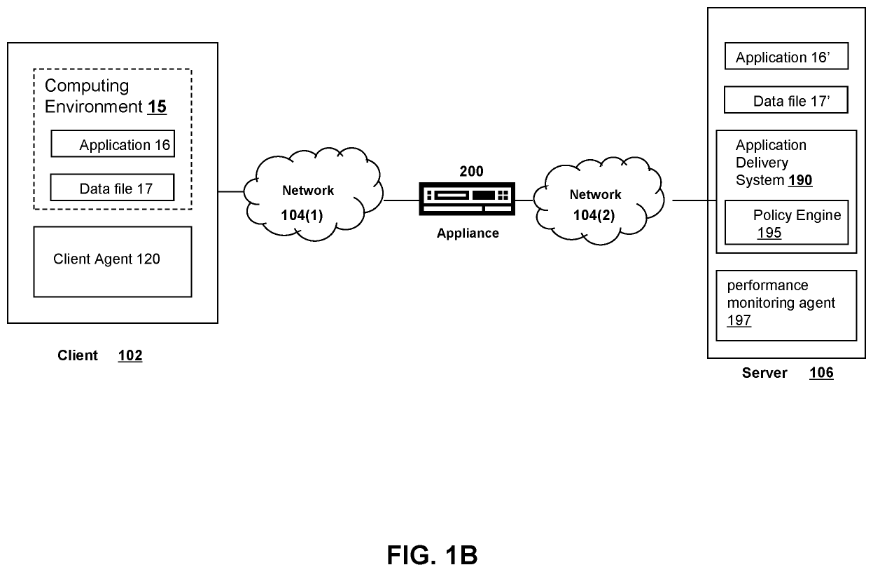

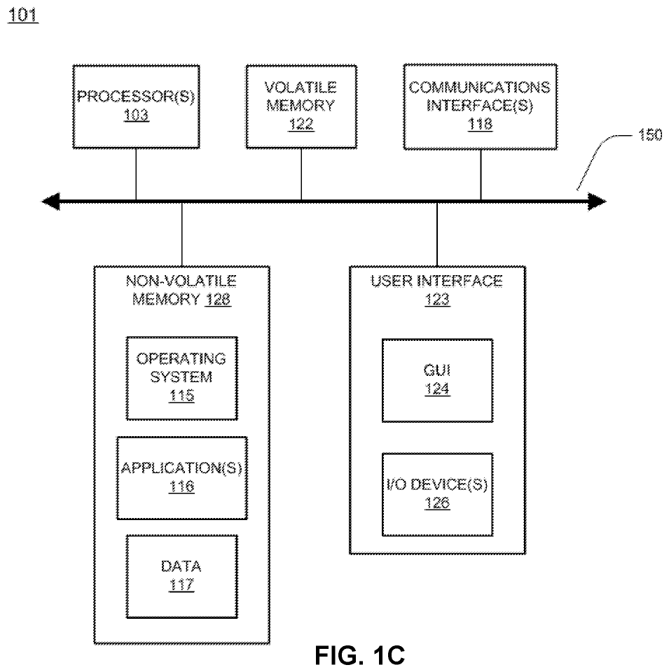

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, Fla.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, Fla.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suitem by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, Fla. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, Fla.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

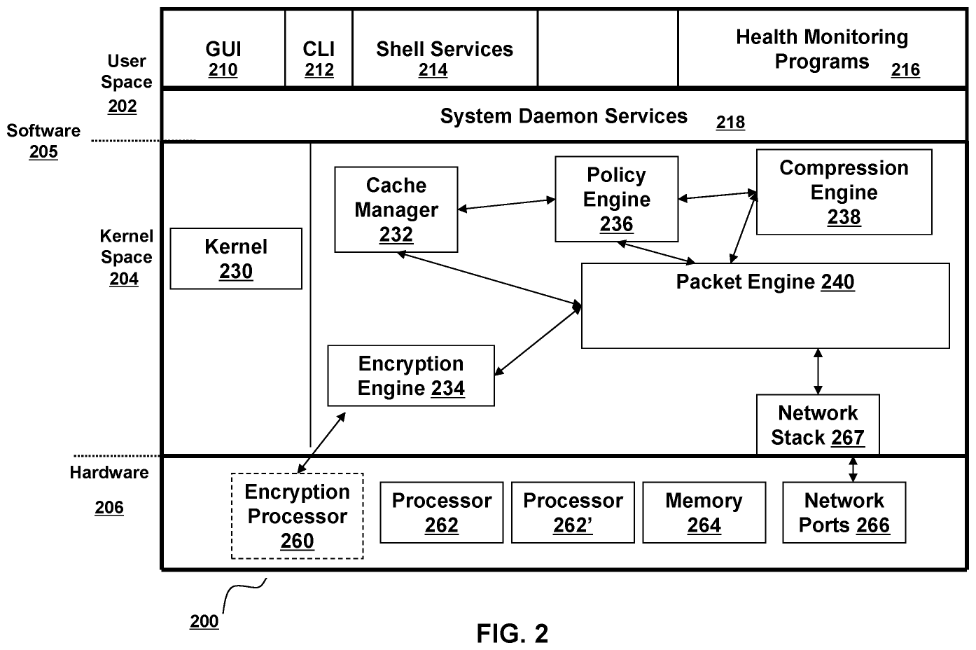

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, Fla. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

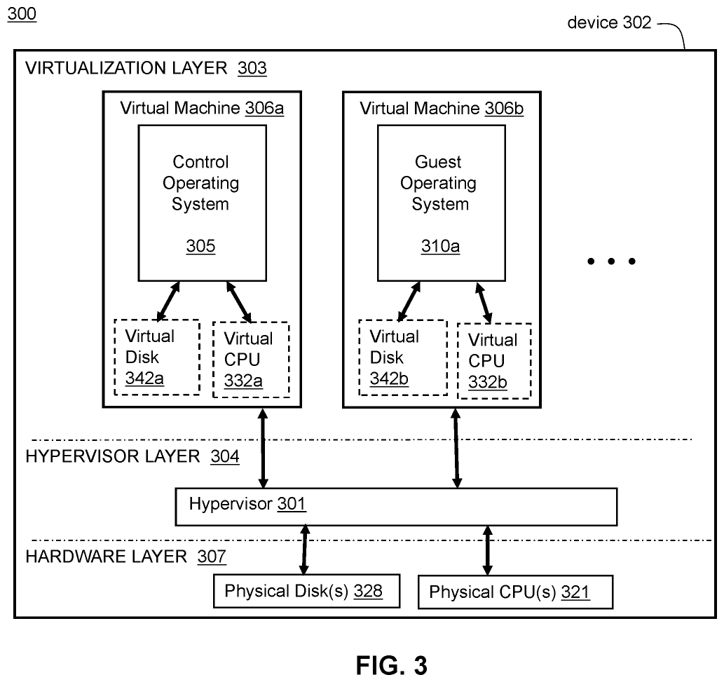

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, Fla. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

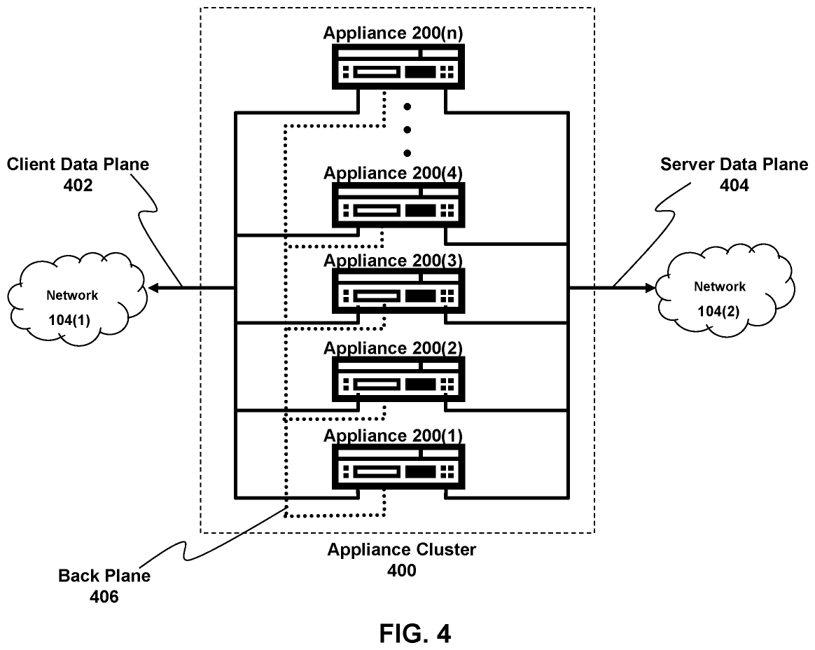

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Service Graph Based Platform and Technology

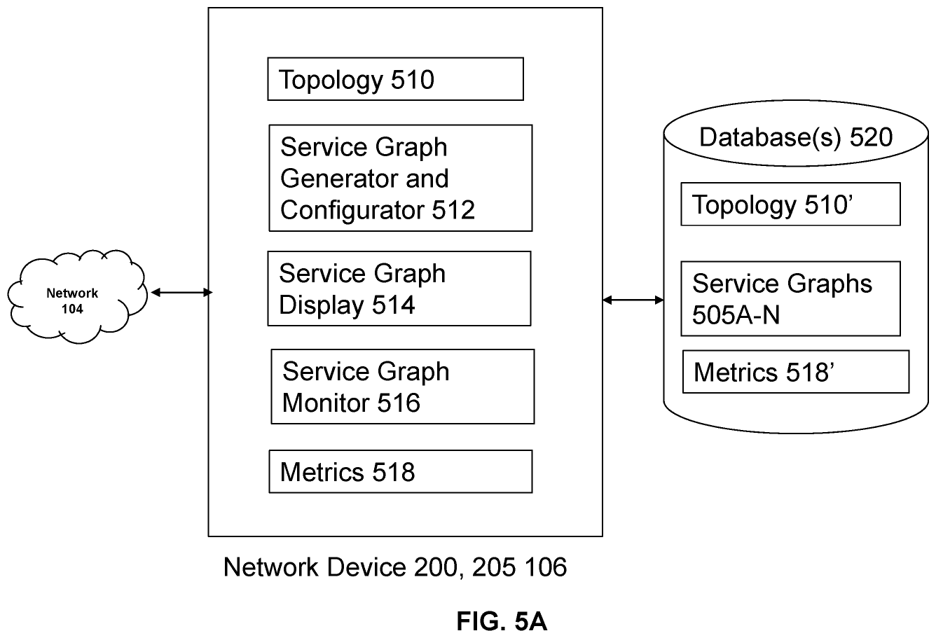

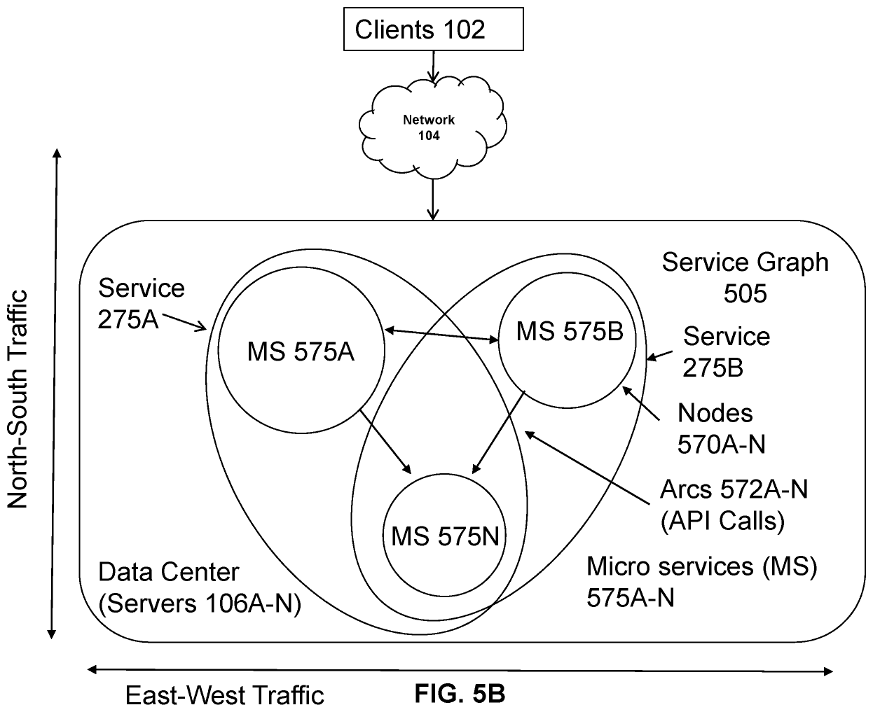

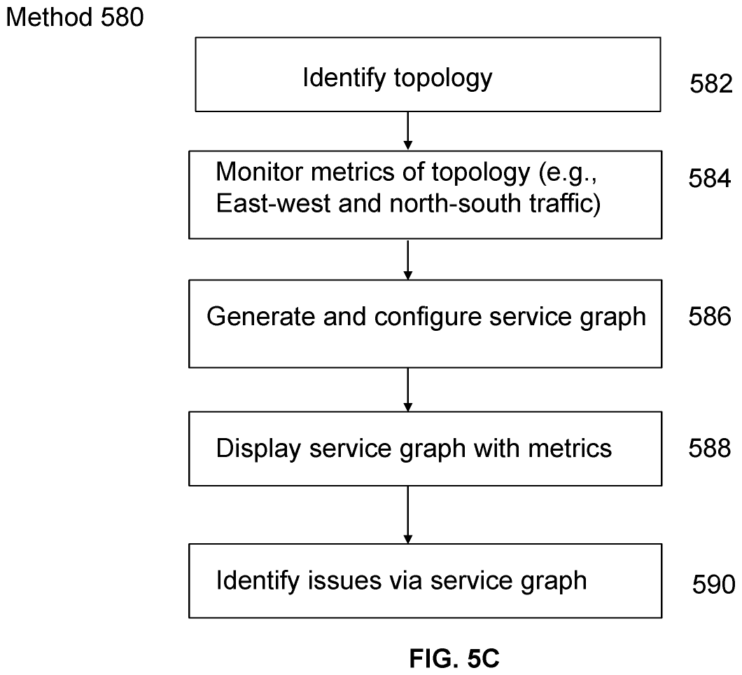

Referring now to FIGS. 5A-5C, implementation of systems and methods for a service graph based platform and technology will be discussed. A service graph is a useful technology tool for visualizing a service by its topology of components and network elements. Services may be made up of microservices with each microservice handling a particular set of one or more functions of the service. Network traffic may traverse the service topology such as a client communicating with a server to access service (e.g., north-south traffic). Network traffic of a service may include network traffic communicated between microservices of the services such as within a data center or between data centers (e.g., east-west traffic). The service graph may be used to identify and provide metrics of such network traffic of the service as well as operation and performance of any network elements used to provide the service. Service graphs may be used for identifying and determining issues with the service and which part of the topology causing the issue. Services graphs may be used to provide for administering, managing and configuring of services to improve operational performance of such services.

Referring to FIG. 5A, an implementation of a system for service graphs, such as those illustrated in FIG. 5B, will be described. A device on a network, such as a network device 200, 205 or a server 206, may include a service graph generator and configurator 512, a service graph display 514 and service graph monitor 516. The service graph generator and configurator 512 (generally referred to as service graph generator 512), may identify a topology 510 of elements in the network and metrics 518 related to the network and the elements, to generate and/or configure service graphs 505A-N. The service graphs 505A-N (generally referred to as service graphs 505) may be stored in one or more databases, with any of the metric 518′ and/or topology 510′. The service graphic generator 512 may generate data of the service graphs 505 to be displayed in a display or rendered form such as via a user interface, generated referred to as service graph display 514. Service graph monitor 516 may monitor the network elements of the topology and service for metrics 518 to configure and generate a service graph 505 and/or to update dynamically or in real-time the elements and metrics 518 of or represented by a service graph display 514.

The topology 510 may include data identifying, describing, specifying or otherwise representing any elements used, traversed in accessing any one or more services or otherwise included with or part of such one or more services, such as any of the services 275 described herein. The topology may include data identifying or describing any one or more networks and network elements traversed to access or use the services, including any network devices, routers, switches, gateways, proxies, appliances, network connections or links, Internet Service Providers (ISPs), etc. The topology may include data identifying or describing any one or more applications, software, programs, services, processes, tasks or functions that are used or traversed in accessing a service. In some implementations, a service may be made up or include multiple microservices, each providing one or more functions, functionality or operations of or for a service. The topology may include data identifying or describing any one or more components of a service, such as programs, functions, applications or microservices used to provide the service. The topology may include parameters, configuration data and/or metadata about any portion of the topology, such as any element of the topology.

A service graph 505 may include data representing the topology of a service 275, such any elements making up such a service or used by the service, for example as illustrated in FIG. 5B. The service graph may be in a node base form, such as graphical form of nodes and each node representing an element or function of the topology of the service. A service graph may represent the topology of a service using nodes connected among each other via various connectors or links, which may be referred to as arcs. The arc may identify a relationship between elements connected by the arc. Nodes and arcs may be arranged in a manner to identify or describe one or more services. Nodes and arcs may be arranged in a manner to identify or describe functions provided by the one or more services. For example, a function node may represent a function that is applied to the traffic, such as a transform (SSL termination, VPN gateway), filter (firewalls), or terminal (intrusion detection systems). A function within the service graph might use one or more parameters and have one or more connectors.

The service graph may include any combination of nodes and arcs to represent a service, topology or portions thereof. Nodes and arcs may be arranged in a manner to identify or describe the physical and/or logical deployment of the service and any elements used to access the service. Nodes and arcs may be arranged in a manner to identify or describe the flow of network traffic in accessing or using a service. Nodes and arcs may be arranged in a manner to identify or describe the components of a service, such as multiple microservices that communicate with each other to provide functionality of the service. The service graph may be stored in storage such as a database in a manner in order for the service graph generator to generate a service graph in memory and/or render the service graph in display form 514.

The service graph generator 512 may include an application, program, library, script, service, process, task or any type and form of executable instructions for establishing, creating, generating, implementing, configuring or updating a service graph 505. The service graph generator may read and/or write data representing the service graph to a database, file or other type of storage. The service graph generator may comprise logic, functions and operations to construct the arrangement of nodes and arcs to have an electronic representation of the service graph in memory. The service graph generator may read or access the data in the database and store data into data structures and memory elements to provide or implement a node based representation of the service graph that can be updated or modified. The service graph generator may use any information from the topology to generate a service graph. The service graph generator may make network calls or use discovery protocols to identify the topology or any portions thereof. The service graph generator may use any metrics, such as in memory or storage or from other devices, to generate a service graph. The service graph generator may comprise logic, functions and operations to construct the arrangement of nodes and arcs to provide a graphical or visual representation of the service graph, such as on a user interface of a display device. The service graph generator may comprise logic, functions and operations to configure any node or arc of the service graph to represent a configuration or parameter of the corresponding or underlying element represented by the node or arc. The service graph generator may comprise logic, functions and operations to include, identify or provide metrics in connection with or as part of the arrangement of nodes and arcs of the service graph display. The service graph generator may comprise an application programming interface (API) for programs, applications, services, tasks, processes or systems to create, modify or interact with a service graph.

The service graph display 514 may include any graphical or electronic representation of a service graph 505 for rendering or display on any type and form of display device. The service graph display may be rendered in visual form to have any type of color, shape, size or other graphical indicators of the nodes and arcs of the service graph to represent a state or status of the respective elements. The service graph display may be rendered in visual form to have any type of color, shape, size or other graphical indicators of the nodes and arcs of the service graph to represent a state or status of one or more metrics. The service graph display may comprise any type of user interface, such as a dashboard, that provides the visual form of the service graph. The service graph display may include any type and form of user interface elements to allow users to interact, interface or manipulate a service graph. Portion of the service graph display may be selectable to identify information, such as metrics or topology information about that portion of the service graph. Portions of the service graph display may provide user interface elements for users to take an action with respect to the service graph or portion thereof, such as to modify a configuration or parameter of the element.

The service graph monitor 518 may include an application, program, library, script, service, process, task or any type and form of executable instructions to receive, identify, process metrics 518 of the topology 510. The service graph monitor 518 monitors via metrics 518 the configuration, performance and operation of elements of a service graph. The service graph monitor may obtain metrics from one or more devices on the network. The service graph monitor may identify or generate metrics from network traffic traversing the device(s) of the service graph monitor. The service graph monitor may receive reports of metrics from any of the elements of the topology, such as any elements represented by a node in the service graph. The service graph monitor may receive reports of metrics from the service. From the metrics, the service graph monitor may determine the state, status or condition of an element represented in or by the service graph, such as by a node of the service graph. From the metrics, the service graph monitor may determine the state, status or condition of network traffic or network connected represented in or by the service graph, such as by an arc of the service graph. The service graph generator and/or service graph monitor may update the service graph display, such as continuously or in predetermined frequencies or event based, with any metrics or any changed in the state, status or condition of a node or arc, element represented by the node or arc, the service, network or network traffic traversing the topology.

The metrics 518, 518′ (generally referred to as metrics 518) may be stored on network device in FIG. 5B, such as in memory or storage. The metrics 518, 518′ may be stored in a database on the same device or over a network to another device, such as a server. Metrics may include any type and form of measurement of any element of the topology, service or network. Metrics may include metrics on volume, rate or timing of requests or responses received, transmitted or traversing the network element represented by the node or arc. A Metrics may include metrics on usage of a resource by the element represented by the node or arc, such as memory, bandwidth. Metrics may include metrics on performance and operation of a service, including any components or microservices of the service, such as rate of response, transaction responses and times.

FIG. 5B illustrates an implementation of a service graph in connection with microservices of a service in view of east-west network traffic and north-south network traffic. In brief overview, clients 102 may access via one or more networks 104 a data center having servers 106A-106N (generally referred to as servers 106) providing one or more services 275A-275N (generally referred to as services 275). The services may be made up multiple microservices 575A-575N (generally referred to as microservice or micro service 575). Service 275A may include microservice 575A and 575N while service 275B may include microservice 575B and 575N. The microservices may communicate among the microservices via application programming interface (APIs). A service graph 505 may represent a topology of the services and metrics on network traffic, such as east-west network traffic and north-south network traffic.

North-south network traffic generally describes and is related to network traffic between clients and servers, such as client via networks 104 to servers of data center and/or servers to clients via network 104 as shown in FIG. 5B. East-west network traffic generally describes and is related to network traffic between elements in the data centers, such as data center to data center, server to server, service to service or microservice to microservice.

A service 275 may comprise microservices 575. In some aspects, microservices is a form of service-oriented architecture style wherein applications are built as a collection of different smaller services rather than one whole or singular application (referred to sometimes as a monolithic application). Instead of a monolithic application, a service has several independent applications or services (e.g., microservices) that can run on their own and may be created using different coding or programming languages. As such, a larger server can be made up of simpler and independent programs or services that are executable by themselves. These smaller programs or services are grouped together to deliver the functionalities of the larger service. In some aspects, a microservices based service structures an application as a collection of services that may be loosely coupled. The benefit of decomposing a service into different smaller services is that it improves modularity. This makes the application or service easier to understand, develop, test, and be resilient to changes in architecture or deployment.

A microservice includes an implementation of one or more functions or functionality. A microservice may be a self-contained piece of business function(s) with clear or established interfaces, such as an application programming interface (API). In some implementations, a microservice may be deployed in a virtual machine or a container. A service may use one or more functions on one microservice and another one or more functions of a different microservice. In operating or executing a service, one microservice may make API calls to another microservice and the microservice may provide a response via an API call, event handler or other interface mechanism. In operating or executing a microservice, the microservice may make an API call to another microservice, which in its operation or execution, makes a call to another microservice, and so on.

The service graph 505 may include multiple nodes 570A-N connected or linked via one or more or arcs 572A-572N. The service graph may have different types of nodes. A node type may be used to represent a physical network element, such as a server, client, appliance or network device. A node type may be used to represent an end point, such as a client or server. A node type may be used to represent an end point group, such as group of clients or servers. A node type may be used to represent a logical network element, such as a type of technology, software or service or a grouping or sub-grouping of elements. A node type may be used to represent a functional element, such as functionality to be provided by an element of the topology or by the service.

The configuration and/or representation of any of the nodes 570 may identify a state, a status and/or metric(s) of the element represented by the node. Graphical features of the node may identify or specify an operational or performance characteristic of the element represented by the node. A size, color or shape of the node may identify an operational state of whether the element is operational or active. A size, color or shape of the node may identify an error condition or issue with an element. A size, color or shape of the node may identify a level of volume of network traffic, a volume of request or responses received, transmitted or traversing the network element represented by the node. A size, color or shape of the node may identify a level of usage of a resource by the element represented by the node, such as memory, bandwidth, CPU or storage. A size, color or shape of the node may identify relativeness with respect to a threshold for any metric associated with the node or the element represented by the node.

The configuration and/or representation of any of the arcs 572 may identify a state, status and/or metric(s) of the element represented by the arc. Graphical features of the arc may identify or specify an operational or performance characteristic of the element represented by the arc. A size, color or shape of the node may identify an operational state of whether the network connection represented by the arc is operational or active. A size, color or shape of the arc may identify an error condition or issue with a connection associated with the arc. A size, color or shape of the arc may identify an error condition or issue with network traffic associated with the arc. A size, color or shape of the arc may identify a level of volume of network traffic, a volume of request or responses received, transmitted or traversing the network connection or link represented by the arc. A size, color or shape of the arc may identify a level of usage of a resource by network connection or traffic represented by the arc, such as bandwidth. A size, color or shape of the node may identify relativeness with respect to a threshold for any metric associated with the arc. In some implementations, a metric for the arc may include any measurement of traffic volume per arc, latency per arc or error rate per arc.

Referring now to FIG. 5C, an implementation of a method for generating and displaying a service graph will be described. In brief overview of method 580, at step 582, a topology is identified, such as for a configuration of one or more services. At step 584, the metrics of elements of the topology, such as for a service are monitored. At step 586, a service graph is generated and configured. At step 588, a service graph is displayed. At step 590, issues with configuration, operation and performance of a service or the topology may be identified or determined.

At step 582, a device identifies a topology for one or more services. The device may obtain, access or receive the topology 510 from storage, such as a database. The device may be configured with a topology for a service, such as by a user. The device may discover the topology or portions therefore via one more discovery protocols communicated over the network. The device may obtain or receive the topology or portions thereof from one or more other devices via the network. The device may identify the network elements making up one or more services. The device may identify functions providing the one or more services. The device may identify other devices or network elements providing the functions. The device may identify the network elements for north-west traffic. The device may identify the network elements for east-west traffic. The device may identify the microservices providing a service. In some implementations, the service graph generator establishes or generates a service graph based on the topology. The service graph may be stored to memory or storage.

At step 584, the metrics of elements of the topology, such as for a service are monitored. The device may receive metrics about the one or more network elements of the topology from other devices. The device may determine metrics from network traffic traversing the device. The device may receive metrics from network elements of the topology, such as via reports or events. The device may monitor the service to obtain or receive metrics about the service. The metrics may be stored in memory or storage, such as in association with a corresponding service graph. The device may associate one or more of the metrics with a corresponding node of a service graph. The device may associate one or more of the metrics with a corresponding arc of a service graph. The device may monitor and/or obtain and/or receive metrics on a scheduled or predetermined frequency. The device may monitor and/or obtain and/or receive metrics on a continuous basis, such as in real-time or dynamically when metrics change.

At step 586, a service graph is generated and configured. A service graph generator may generate a service graph based at least on the topology. A service graph generator may generate a service graph based at least on a service. A service graph generator may generate a service graph based on multiple services. A service graph generator may generate a service graph based at least on the microservices making up a service. A service graph generator may generate a service graph based on a data center, servers of the data center and/or services of the data center. A service graph generator may generate a service graph based at least on east-west traffic and corresponding network elements. A service graph generator may generate a service graph based at least on north-south traffic and corresponding network elements. A service graph generator may configure the service graph with parameters, configuration data or meta-data about the elements represented by a node or arc of the service graph. The service graph may be generated automatically by the device. The service graph may be generated responsive to a request by a user, such as via a comment to or user interface of the device.

At step 588, a service graph is displayed. The device, such as via service graph generator, may create a service graph display 514 to be displayed or rendered via a display device, such as presented on a user interface. The service graph display may include visual indicators or graphical characteristics (e.g., size, shape or color) of the nodes and arcs of the service graph to identify status, state or condition of elements associated with or corresponding to a node or arc. The service graph display may be displayed or presented via a dashboard or other user interface in which a user may monitor the status of the service and topology. The service graph display may be updated to show changes in metrics or the status, state and/or condition of the service, the topology or any elements thereof. Via the service graph display, a user may interface or interact with the service graph to discover information, data and details about any of the network elements, such as the metrics of a microservice of a service.

At step 590, issues with configuration, operation and performance of a service or the topology may be identified or determined. The device may determine issues with the configuration, operation or performance of a service by comparing metrics of the service to thresholds. The device may determine issues with the configuration, operation or performance of a service by comparing metrics of the service to previous or historical values. The device may determine issues with the configuration, operation or performance of a service by identifying a change in a metric. The device may determine issues with the configuration, operation or performance of a service by identifying a change in a status, state or condition of a node or arc or elements represented by the node or arc. The device may change the configuration and/or parameters of the service graph. The device may change the configuration of the service. The device may change the configuration of the topology. The device may change the configuration of network elements making up the topology or the service. A user may determine issues with the configuration, operation or performance of a service by reviewing, exploring or interacting with the service graph display and any metrics. The user may change the configuration and/or parameters of the service graph. The user may change the configuration of the service. The user may change the configuration of the topology. The device may change the configuration of network elements making up the topology or the service.

### F. Systems and Methods for Displaying a Service Graph of Microservices Based at Least on a Namespace

Systems and methods for displaying a service graph of microservices based on namespaces are discussed herein. As described above, a service graph may be a tool by which a service including various microservices corresponding thereto may be visualized. Such a tool may be used for network traffic monitoring purposes, diagnostic purposes, troubleshooting purposes, and so forth. The service graph may depict various metrics corresponding to network conditions and topology (e.g., traffic volume, latency, error rates, and other metrics corresponding to the service). In some implementations, a user may want to view certain microservices of a given service. For instance, the user may want to monitor certain subsets of microservices at a given time.

A device can establish namespaces associated with subsets of the microservices. Each namespace may be associated with a subset of microservices of various service(s). The namespaces may be user-generated, generated by the device based on network traffic flow, etc. The namespaces may be organized by the functions that the respective microservices provide, by a hierarchy of the microservices, a geography or location in which the microservices are deployed, and so forth. A user can request (e.g., on the user's device) displaying of a service graph of microservices corresponding to a selected namespace. The device can generate and display the service graph including the microservices corresponding to the selected namespace. Thus, microservices can be compartmentalized and organized into namespaces for easy selection and display. The user can toggle between namespaces by providing corresponding inputs on the user interface. The device can correspondingly display a service graph on the user interface.

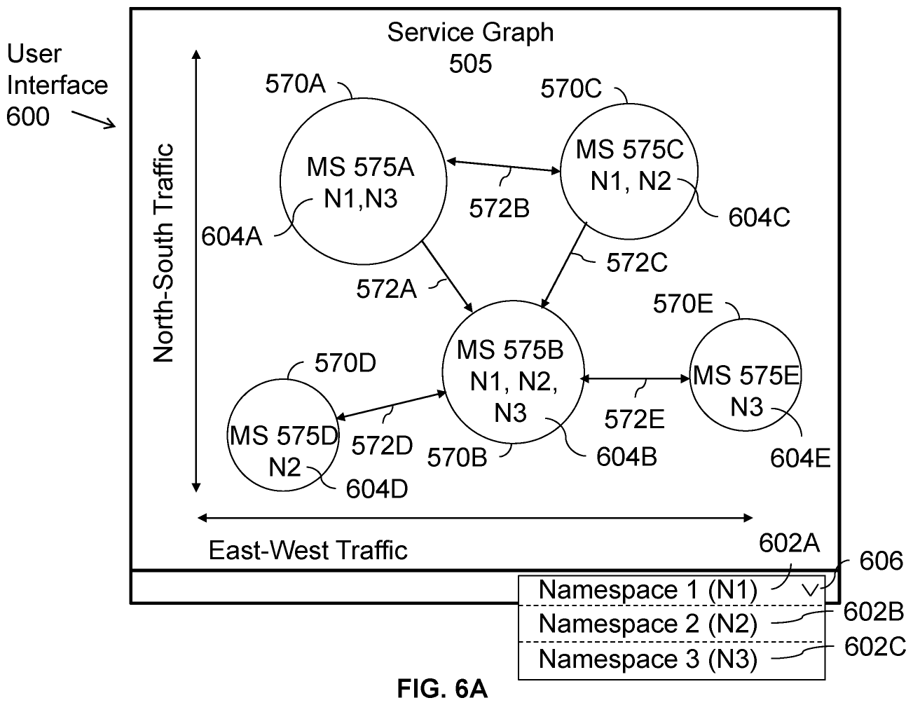

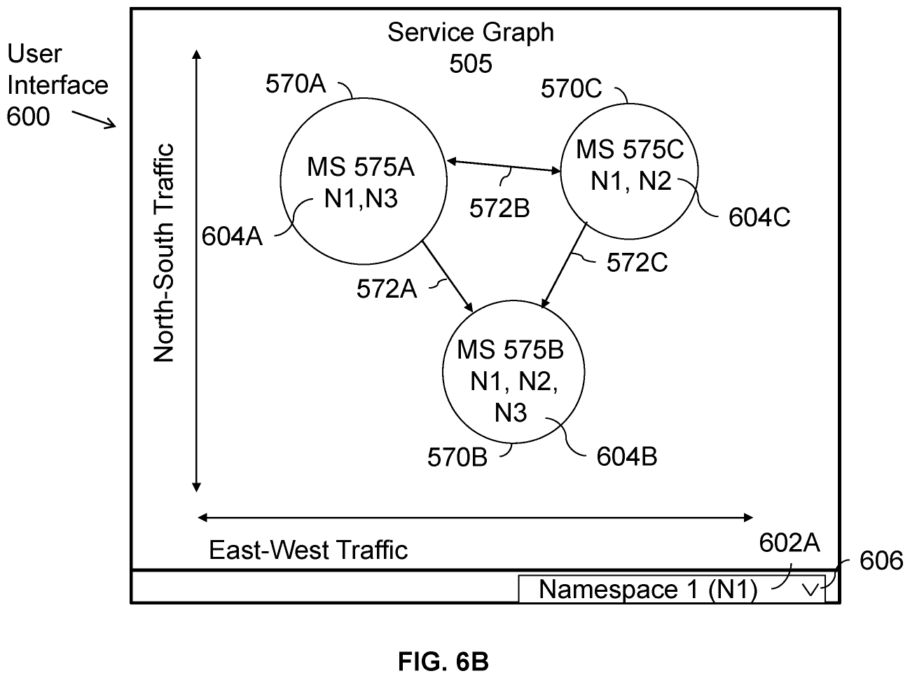

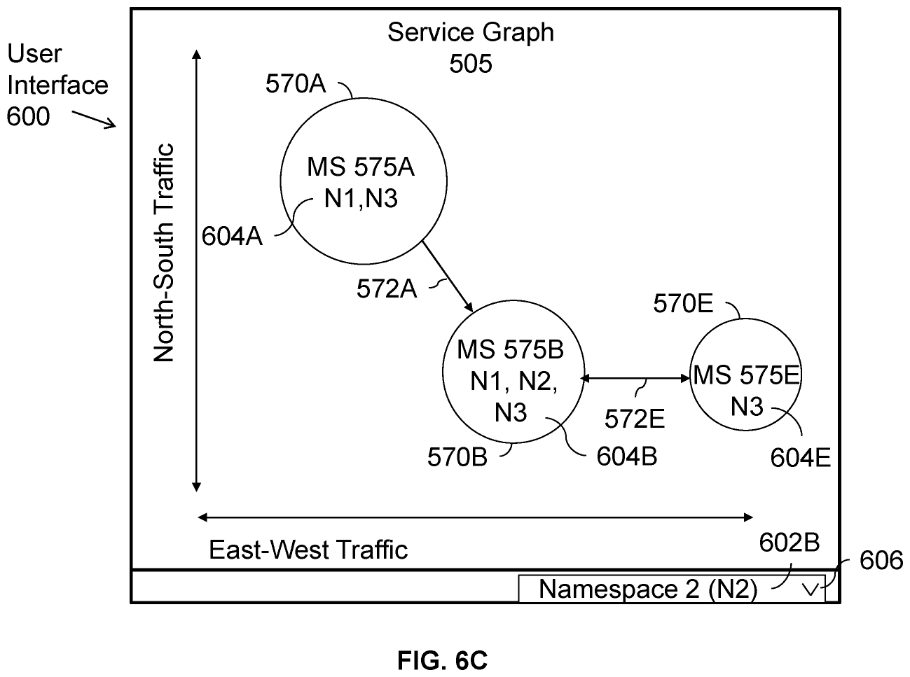

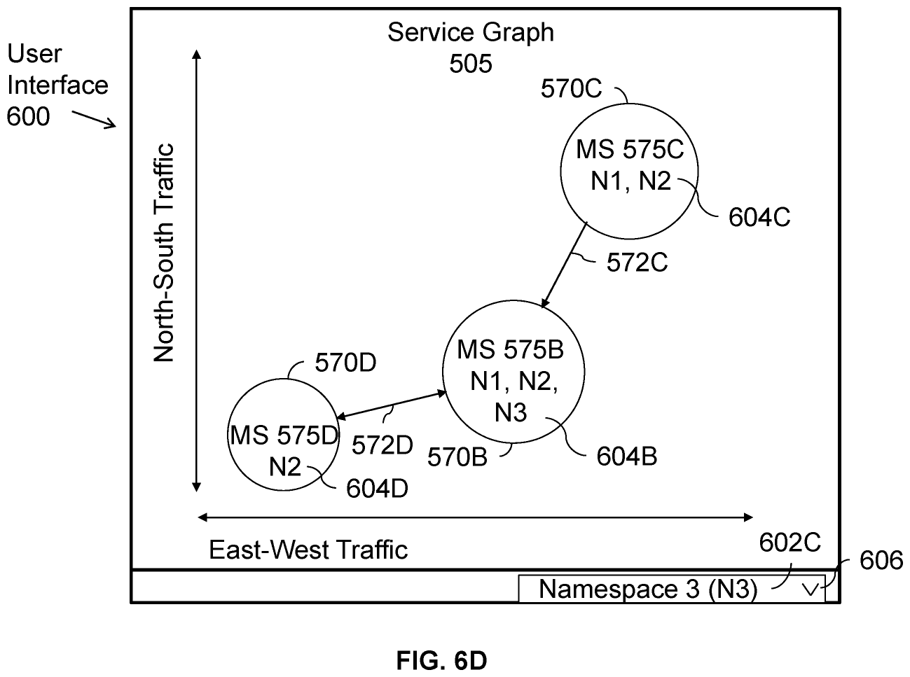

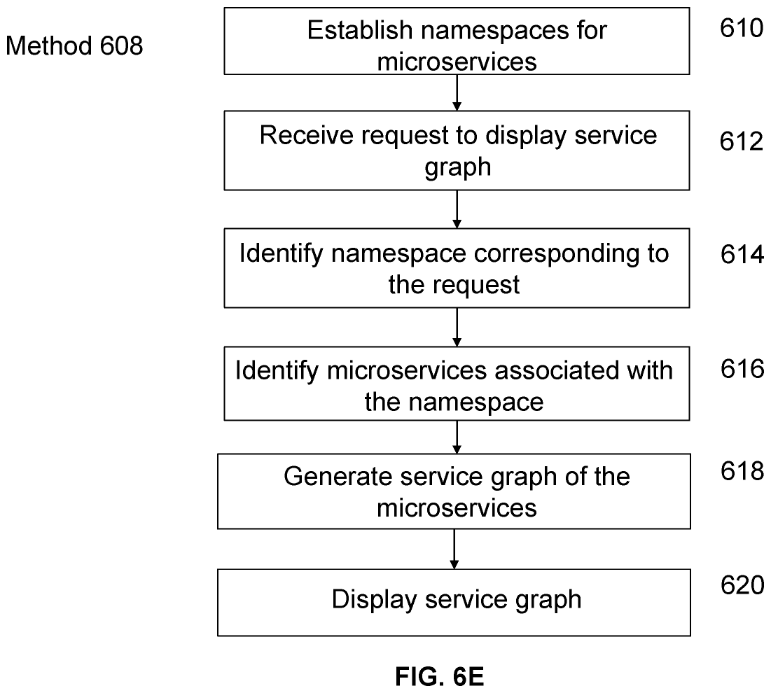

Referring now to FIG. 6A, depicted is an example user interface 600 including a service graph 505. As shown in FIG. 6A, the service graph 505 may include nodes 570A-570E corresponding to respective microservices 575A-575E. The service graph 505 depicted in FIG. 6A may be a service graph 505 of a single service. However, it should be understood that the service graph 505 may be expanded to include additional services. Furthermore, a given service graph 505 may include additional (or fewer) microservices 575 than what is depicted in FIG. 6A. In some implementations, some of the microservices 575 may provide functions to the service represented in FIG. 6A and to other services not shown in FIG. 6A. The service graphs 505 may depict various metrics. For instance, each service graph 505 in the series of service graphs 505 may include metrics corresponding to the particular time at which the service graph 505 was generated, produced, configured, displayed, etc. (e.g., by the service graph generator and configurator 512 as described above). The service graph 505 may represent real-time metrics of the microservices 575.

Referring now to FIG. 5A and FIG. 6A, as described in greater detail above in Section E, the service graph 505 includes any combination of nodes 570A-N and arcs 572A-N that represent a service, topology, or portions thereof. Nodes 570A-N and arcs 572A-N may be arranged to identify or describe the physical and/or logical deployment of the service (e.g., including microservices 575 corresponding to the service), identify or describe the flow of network traffic during access or use of the service, and/or any elements used to access the service. The service graph generator 512 may read and/or write data representing the service graph 505 to a database 520 for use or display, as described in greater detail below. The service graph monitor 516 may be configured to receive, identify, process metrics 518 of the topology 510 corresponding to the service graph 505. The service graph monitor 516 monitors via metrics 518 the configuration, performance and operation of elements of a service graph. The service graph monitor 516 may obtain metrics from one or more devices on the network. The service graph monitor 516 may identify or generate metrics, such as network traffic rate or flow, latency, error rate, etc. from network traffic traversing the device(s) monitored by the service graph monitor 516. The service graph display 514 may be configured to update the service graph 505 (e.g., in real-time) to reflect the metrics identified and/or generated by the service graph monitor 516, as described in greater detail above in Section E.

As shown in FIG. 5A, the database(s) 520 may store information corresponding to the services/microservices. In some embodiments, the database(s) 520 may be configured to store one or more namespaces. Namespaces may be or include an organizational or logical grouping or set of microservices 575 of one or more services. The database(s) 520 may be configured to store a plurality of namespaces. Each namespace may correspond to a set of microservices 575. Some microservices 575 may be included in a plurality of the namespaces. A given service may be constructed of or defined as a group of microservices 575 which together provide the service. The namespaces may include a subset of the microservices 575 for a given service (or services). The namespaces may organize the microservices 575 into logical groupings. As described in greater detail below, the namespaces may be generated based on user inputs, automatically generated based on the microservices and/or service(s) themselves, and so forth. A user may provide an input on a device for displaying a service graph 505 of microservices corresponding to a namespace. The service graph generator 512 may receive the request, generate the service graph 505, and display the service graph 505 on the device of the user.

In some embodiments, the service graph generator 512 may be configured to generate, maintain, organize, or otherwise establish the namespaces. The service graph generator 512 may be configured to establish a plurality of namespaces for each microservices 575 of the service(s). The service graph generator 512 may be configured to store the namespaces in the database 520. As new namespaces are introduced (e.g., by the service graph generator 512 based on introduction of new microservices 575, based on user inputs, based on changes in topology of the service graph 505, etc.), the service graph generator 512 may store the new namespaces in the database 520. The service graph generator 512 may be configured to establish the namespaces by providing, establishing, or otherwise configuring a tag for each of the microservices 575. The microservices 575 may be tagged to identify which namespaces the respective microservices 575 are associated with. The service graph generator 512 may use the tags of the microservices 575 for generating service graphs 505 corresponding to a respective namespace, as described in greater detail below.

The service graph generator 512 may be configured to generate a namespace based on logical groupings of the microservices. The logical groupings may together form a corresponding namespace. Hence, the service graph generator 512 may establish a namespace based on logical groupings of microservices. The logical groupings may be defined based on the service graph 505 topology (e.g., both physical topology, network traffic flow, functionalities of the service, etc.). The logical groupings may be defined based on user inputs (e.g., user-defined logical groupings). The service graph generator 512 may be configured to provide an identifier for a namespace corresponding to a logical group.

As shown in FIG. 6A, the service graph generator 512 may be configured to generate, establish, determine, or otherwise provide an identifier 602 corresponding to a logical group of microservices. In some implementations, the identifier 602 may be a name corresponding to the namespace, a number associated with the namespace, or other identifier which is uniquely associated with a particular logical grouping of microservices. The service graph generator 512 may be configured to provide the identifier 602 based on the logic used for establishing the logical groupings of microservices 575. For instance, where the logical groupings are provided by a user, the identifier 602 may be a user-defined identifier. Where the logical groupings are established based on a geographic location at which the microservices are deployed, the identifier 602 may be a location-based identifier. Where the logical groupings are established based on the functions of the respective microservices, the identifier 602 may be a functionality-based identifier. Where the logical groupings are established based on a hierarchy of microservices, the identifier 602 may be hierarchical-based identifier. Where the logical groupings are established based on resolution of the service, the identifier 602 may be resolution-based identifier. In these and other embodiments, the identifier 602 may be used for defining a group of microservices (which together may form a namespace). In some embodiments, the service graph generator 512 may be configured to generate namespaces within namespaces (e.g., nested namespaces). For instance, one or more of the namespaces described below may include nested namespaces which further group the subset of microservices 575 into smaller groups (or different levels). As such, for a given namespace, varying degrees of details may be included in a service graph 505.

The service graph generator 512 may be configured to provide, generate, establish or otherwise configure one or more tags 604 to each of the microservices 575. The service graph generator 512 may configure the tags 604 to the microservices 575 based on the logical groupings of microservices 575 described above. The tag 604 may correspond to the identifier 602 of the respective logical groupings. Continuing the example depicted in FIG. 6A, each microservice 575 may include a tag 604A-604E indicating the logical groupings in which the respective microservice 575 is a member. For instance, microservice 575A includes a tag 604A indicating the logical groupings for microservice 575A (e.g., indicating the microservice 575A is a member of the logical grouping corresponding to identifier 602A and the logical grouping corresponding to identifier 602C). Similarly, microservice 575B includes a tag 604B indicating the logical groupings for microservice 575B (e.g., indicating the microservice 575B is a member of the logical grouping corresponding to identifier 602A, the logical grouping corresponding to identifier 602B, and the logical grouping corresponding to identifier 602C). Each microservice 575 may include a respective tag (or tags) which indicate the logical groupings of which the microservice 575 is a member. As described in greater detail below, the service graph generator 512 may identify the identifier 602 in a request for displaying a service graph 505 and use the tags 604 for identifying the corresponding microservices 575 for including in the service graph 505.

The service graph generator 512 may be configured to generate a namespace based on a function or functionality implemented by a microservice 575 (or group of microservices 575). As described above in Section E, services may be made up of microservices 575 with each microservice 575 handling a particular set of one or more functions of the service. The service graph generator 512 may include, maintain, store, or otherwise access data corresponding to the function(s) in which each microservice 575 performs. The service graph generator 512 may be configured to identify groupings of microservices 575 based on the functions in which the microservices 575 perform. For instance, where a group of functions together provide a functionality for a service, the service graph generator 512 may generate a namespace corresponding to the functionality which includes each of the microservices 575 which provide the functions that together provide the functionality of the service.

In the example depicted in FIG. 6A, the service provided by each of the microservices 575 may be a search engine service. One group of microservices may provide a searching functionality, another group of microservices may provide a user interface management functionality, and another group of microservices may provide a data management functionality. The service graph generator 512 may generate namespaces for each of the functionalities. As an example, where the functionality is a searching functionality, one microservice 575C may provide a function for receiving an input, another microservice 575A may provide a function for processing the input to determine a requested search, and another microservice 575B may provide a function for data retrieval. Each of these microservices 575A-575C may together provide the searching functionality. Microservices 575C and 575B may also provide functions for the user interface management functionalities (e.g., together with microservice 575D). Microservices 575A and 575B may also provide functions for the data management functionality (e.g., together with microservice 575E). Hence, some microservices 575 may provide functions for multiple functionalities. [RcO1]

The service graph generator 512 may be configured to group together microservices 575 based on the functions in which the microservices perform. The service graph generator 512 may be configured to maintain a list of functionalities of a service. Each of the functionalities may be linked to respective functions. The service graph generator 512 may identify each of the microservices that provide the respective functions for a given functionality (e.g., by identifying the functions linked to the functionality, and identifying the microservices 575 which perform the respective functions). The service graph generator 512 may be configured to generate a namespace for each of the functionalities for a given service. The service graph generator 512 may include microservices 575 in a respective namespace based on the functions linked to the functionality for the namespace. Hence, continuing the example above, the namespace for the searching functionality may include the microservices which provide the functions of receiving an input, processing the input to determine a requested search, and data retrieval.

As shown in FIG. 6B-6D, various examples of groupings of microservices within respective services graphs are shown. In the examples shown in FIG. 6B-6D, the groupings of microservices 575 may be based on the functions provided by the respective microservices. Continuing the example above, FIG. 6B may be the microservices 575 corresponding to the namespace for the searching functionality, FIG. 6C may be the microservices 575 corresponding to the namespace for the user interface management functionality, and FIG. 6D may be the microservices 575 corresponding to the namespace for the data management functionality. Each of the functionalities may together provide the service (e.g., represented in the service graph 505 shown in FIG. 6A). While these examples are provided, the namespaces may be organized, structured, or otherwise generated based on other characteristics for the namespaces.

The service graph generator 512 may be configured to generate a namespace based on a geography or a location at which a microservice 575 is deployed. Each microservice 575 may be deployed on a respective computing device, processor, or other server. In some implementations, the servers may be spread across different geographical regions (e.g., different city, state, region, country, etc.). For instance, a server in a first location may include a first grouping of microservices 575 while a server in a second location may include a second grouping of microservices 575. The service graph generator 512 may be configured to maintain a list, ledger, or other database corresponding to a location of each of the servers on which respective microservices 575 are deployed. The service graph generator 512 may be configured to identify on which server each microservice 575 is deployed. The service graph generator 512 may be configured to identify the server based on data generated by the microservice 575 (e.g., an IP address for the server in the metadata generated by the microservice 575). The service graph generator 512 may be configured to group together a set of microservices 575 deployed on the same servers.

In some embodiments, some servers may be located at the same or substantially the same location (for instance, some servers may together form a bank of servers at the same location). The service graph generator 512 may be configured to maintain data corresponding to a location associated with each of the servers. The service graph generator 512 may be configured to group together the sets of microservices deployed on servers within the same (or substantially the same) location. The service graph generator 512 may be configured to generate namespaces based on the geographic locations of the servers on which the microservices 575 are deployed. A first namespace may include microservices deployed on one server at a first location and a second namespace may include microservices deployed on another server at a different location. In some implementations, the namespaces may group together microservices 575 deployed on servers located at substantially the same location (e.g., within a server bank). Hence, the namespaces may include microservices 575 deployed on respective servers located at substantially the same location. In these and other embodiments, the namespaces may generally group together microservices 575 corresponding to various service(s) based on a location or geography at which the microservices 575 are deployed.

The service graph generator 512 may be configured to generate a namespace based on a hierarchy of the microservices. Each microservice may be ranked within a respective hierarchy. In some implementations, the hierarchy may be based on a relationship between the microservices which make up a respective service. Some of the microservices may work together to provide the functionalities of the service. Some microservices may be subordinate to other microservices. By way of example, a first microservice may provide a function which is used by second microservice to provide a corresponding function. In this example, the first microservice may be subordinate to the second microservice. As another example, some microservices may work independently to provide different functions. The service graph generator 512 may be configured to use the topology of the microservices 575 to identify or otherwise determine the hierarchy.

Continuing the example shown in FIG. 6A, microservice 575B may have the highest position within the hierarchy, as the microservice 575B receives inputs from each of the other microservices 575A, 575C, 575D, 575E. Each of the other microservices 575 for the service may have a position within the hierarchy beneath the microservice 575B. Microservices 575A and 575C may have a position at the same level as each other within the hierarchy. Similarly, microservices 575D and 575E may have a position at the same level as each other within the hierarchy. Microservices 575A and 575C may have a position above the position of microservices 575D and 575E. Microservices 575A and 575C may have a higher position within the hierarchy because these microservices 575 provide functions to each other as well as microservice 575B, whereas microservices 575D and 575E only provide functions to microservice 575B.

The service graph generator 512 may be configured to determine which microservices 575 provide data and traffic to other microservices 575 in establishing, generating, or otherwise determining the hierarchy. The service graph generator 512 may determine the hierarchy based on the network traffic flow across the microservices 575. The service graph generator 512 may determine the hierarchy based on which microservices 575 receive the most functions for providing a corresponding function (e.g., microservice 575B). The service graph generator 512 may determine the hierarchy for the remaining microservices 575 relative to the microservice 575 receiving the most functions.

In some implementations, the hierarchy may be based on criticality. Some microservices may be more critical than other microservices. The criticality may be based on the network traffic handled by the respective microservices (e.g., more critical microservices handle more network traffic), based on the function in which the microservice provides (e.g., microservices which provide functions that are used more frequently may be more critical), based on the age of the microservice (e.g., older microservices may be more critical than newer microservices), and so forth. The service graph generator 512 may be configured to identify network traffic handled by the respective microservices using the metrics 518 for the service graph 505 as described above. The service graph generator 512 may be configured to identify the frequency of use based on the number of functionalities in which a respective microservice 575 is linked as described above (e.g., a microservice 575 linked to more functionalities may be used more frequently). The service graph generator 512 may be configured to identify an age of the microservice 575 based on a timestamp (e.g., origination timestamp, update timestamp, etc.) associated with the microservice 575 relative to timestamps for other microservices 575.

The service graph generator 512 may be configured to establish tiers, groupings, or other layers of microservices based on the hierarchy. Each of the layer may include a corresponding grouping of microservices. Hence, as more layers are added to the service graph 505, more microservices 575 may be included in the service graph 505. In other words, the resolution of the service graph 505 may increase as more layers are added to the service graph 505. The layers may be organized based on the hierarchy. For instance, the service graph generator 512 may be configured to generate a first layer of microservices 575, a second layer of microservices 575, a third layer of microservices 575, etc. As the resolution increases (e.g., more layers are included in the service graph 505), more microservices 575 may be included in the service graph 505. As such, the resolution may be a function of the amount or level of detail included in the service graph 505. A first grouping of microservices 575 may include the microservices 575 having the highest position(s) within the hierarchy (for instance, microservice 575B). A second grouping may include the first grouping of microservices 575 and those microservices having positions within the hierarchy beneath the position of the microservices in the first grouping (e.g., microservices 575A and 575C). A third grouping may include the first and second groupings of microservices 575 and microservices having positions within the hierarchy beneath the position of the microservices in the second grouping (e.g., microservice 575D and 575E).

The service graph generator 512 may be configured to generate a namespace based on user selection. The namespace may be a user-defined (or custom) namespace. A user may generate a namespace using their computing device. The user may provide a name, title, or other identifier 602 corresponding to the namespace and a list of microservices to be included in the namespace. The user may generate the namespace when the user wants to monitor specific microservices. For instance, the user may be tasked with monitoring certain microservices at a given point in time (e.g., during high traffic conditions, for instance). The user may generate a custom namespace so that the service graph 505 is less cluttered (e.g., the service graph 505 only includes microservices which the user is to monitor). The service graph generator 512 may be configured to receive the custom namespace from the user, and store the namespace (e.g., data corresponding to the namespace) in the database 520 grouped with the other namespaces.

The service graph generator 512 may be configured to receive a request to display a service graph of the microservices 575. The service graph generator 512 may be configured to receive the request from a device associated with a user (e.g., a network administrator, software developer, etc.) across the network 104. The request may identify, include, or otherwise select a namespace. The user may select the namespace based on which microservices 575 the user wants to monitor. The user may select the namespace on the user interface 600 (e.g., via a drop-down menu 606 including identifiers 602 of each of the namespaces as shown in FIG. 6A). In some embodiments, the user may select the namespace on a separate user interface (e.g., for the same application corresponding to the system or a separate application) which triggers launching, displaying, or other rendering of the user interface 600 including the service graph 505 corresponding to the selected namespace.

The service graph generator 512 may be configured to generate a service graph 505 based on the selected namespace. The service graph generator 512 may be configured to identify the namespace using the request. The service graph generator 512 may parse the request from the user to extract the identifier 602 corresponding to the selected namespace. The service graph generator 512 may be configured to identify the microservices 575 linked to the namespace using the identifier 602 and tags 604 associated therewith. As described above, the tags 604 may indicate which namespaces the respective microservice 575 is a member. The service graph generator 512 may be configured cross-reference the tags 604 for each of the microservices 575 against the identifier 602 of the request to identify the microservices 575 corresponding to the microservices 575. In some embodiments, the identifier 602 may be a value within a ledger or database that includes entries corresponding to identifiers and the microservices 575 linked thereto. The service graph generator 512 may be configured to identify the microservices 575 for a namespace by performing a look-up function within the database using the identifier 602 from the request.

The service graph generator 512 may be configured to generate the service graph 505 for the selected namespace. The service graph 505 may include nodes 570 representing the microservices 575 within or corresponding to the selected namespace. The service graph 505 may include arcs 572 which connect the nodes 570 corresponding to microservices corresponding to the selected namespace. Hence, the service graph 505 may maintain at least some aspects of the structure of the service graph 505 of the overall service, but may be limited to include the microservices 575 corresponding to the namespace.

The service graph display 514 may be configured to receive the generated service graph 505 from the service graph generator 512 and display the service graph 505 to the user. The service graph display 514 may display the service graph 505 by communicating the service graph 505 (or data for rendering the service graph) to the device of the user. The device may display the service graph 505 on a screen of the device. The service graph display 514 may display service graphs 505 similar to those service graphs shown in FIG. 6B-6D. In such embodiments, the user interface 600 shown in FIG. 6B may correspond to one namespace, the user interface 600 shown in FIG. 6C may correspond to another namespace, and the user interface 600 shown in FIG. 6D may correspond to yet another namespace. The user may toggle through namespaces by providing a corresponding input on the user interface 600 (e.g., via the drop-down menu 606). The service graph display 514 may correspondingly display a new service graph 505 for the selected namespace.

Referring now to FIG. 6B, an implementation of a method 608 for displaying a service graph of microservices based at least on a namespace will be described. In brief overview of method 608, at step 610, a device establishes namespaces for microservices. At step 612, the device receives a request to display a service graph. At step 614, the device identifies a namespace corresponding to the request. At step 616, the device identifies microservices associated with the namespace. At step 618, the device generates a service graph of the microservices. At step 620, the device displays the service graph.

At step 610, a device establishes namespaces for microservices. In some embodiments, the device may establish a namespace of a plurality of namespaces for each of a plurality of microservices of one or more services. The device may be embodied on, a component or element of, or otherwise associated with the systems described above in FIG. 1A-FIG. 5B. The device may establish a namespace responsive to receiving a user request including a user-defined namespace. The device may establish a namespace responsive to identifying a topology, layout, or configuration of the microservice(s) corresponding to various services.

The device may establish namespaces to include various groups, sets, etc. of microservices. The device may establish namespaces based on the geography or location in which microservices are deployed, based on functions provided by the corresponding microservices, based on a hierarchy of the microservices, based on a criticality of the microservices, and so forth. In some embodiments, the namespaces may correspond to layers of microservices. For instance, a first namespace may include a first set of microservices, a second namespace may include the microservices from the first set and additional microservices, and so forth. Thus, the namespaces may include layers of microservices. The layers may be defined based on the hierarchy of microservices for the service(s). As further layers are included in a service graph, the resolution of the service graph may increase. The device may establish the namespaces as described above. In some implementations, the namespaces may be generated, revised, modified, updated, etc. as new microservices are rolled out (or as existing microservices are modified, updated, replaced, etc.). The device may establish the namespaces to include any logical grouping of microservices.

The device may establish the namespaces by configuring tag(s) of the microservices. The tags may identify the namespace(s) of the microservice. Hence, a microservice may be a member of a plurality of namespaces. The tag may identify each of the namespaces to which a given microservice is a member. The tag may be configured based on an identifier for the respective namespace(s) of the microservice. As a microservice is associated with, included in, or otherwise linked to additional namespace(s), the device may revise the tag, add a new tag, etc. to indicate the microservice being linked to new namespace(s). In some implementations, the tag may match an identifier for the microservice. As described in greater detail below, the device may use the tags for identifying microservices associated with a respective namespace.

At step 612, the device receives a request to display a service graph. In some embodiments, the device may receive a request to display a service graph of the plurality of microservices corresponding to a selected namespace of the plurality of namespaces. The device may receive the request from a computing device of a user (such as an IT or network administrator, a software developer, etc.). The user may generate the request by providing an input to a user interface linked to the device. The user may generate the request by indicating a namespace corresponding to microservices which the user wants to monitor/view. The user may select the namespace from a plurality of namespaces (e.g., established at step 610). The user may select the namespace from a drop-down menu on the user interface, for instance. The user may select the namespace based on a resolution. The user may select the resolution to indicate how detailed a service graph the user wants to monitor/view. The user may select a higher resolution namespace (or higher resolution within a selected namespace) where the user wants to monitor/view a detailed service graph, whereas the user may select a lower resolution where the user wants to monitor/view a high-level service graph.

At step 614, the device identifies a namespace corresponding to the request. The request (e.g., received at step 612) may include an identifier corresponding thereto. The identifier may be associated with a particular namespace. The device may extract the identifier from the request. The device may use the identifier to identify the namespace corresponding to the request. At step 616, the device identifies microservices associated with the namespace. The device may identify the microservices based on the identifier for the namespace. The device may access a database including identifiers and corresponding microservices. The device may cross-reference the identifier from the request with the database to identify the microservices corresponding to the namespace identified in the request (e.g., at step 614). The device may identify microservices associated with the namespace using the tags linked to the microservices. The tags may indicate the namespaces to which the microservices are a member. The device may identify the namespace (e.g., at step 614), and cross-reference the identified namespace with the tags for the microservices to identify the microservices associated with the namespace.

At step 618, the device generates a service graph of the microservices. In some embodiments, device may generate the service graph including one or more of the microservices associated with the selected namespace. The device may generate the service graph to include each (or a subset) of the microservices identified at step 614. The device may generate the service graph in a manner similar to step 586 of method 580 described above. The device may generate the service graph to reflect network traffic, topology, or other configuration data and conditions. The service graph may reflect the network conditions of the microservice(s) corresponding to the selected namespace in real-time.

In some embodiments, the device may select which of the microservices to include from the namespace in the service graph based on a requested resolution. For instance, were a namespace is linked to many microservices, the microservices within the namespace may themselves include a hierarchy. Hence, the namespaces may include nested namespaces. The user may select an option to view a service graph of a namespace and also select a corresponding resolution. The device may generate a service graph to include the microservices within the nested namespace corresponding to the selected resolution for the selected namespace.

At step 620, the device displays the service graph. In some embodiments, the device may display the service graph for the selected namespace. The device may display the service graph by sending the service graph (or instructions for generating the service graph) to a user who generated the request (e.g., received at step 612). The device may thus trigger displaying of the service graph on a computing device associated with the user. The user may monitor the metrics associated with the microservices corresponding to the namespace. In some implementations, the user may toggle between namespaces being displayed. For instance, the user may select a different namespace than what is currently being displayed using a drop-down menu. The device may receive a request (e.g., based on the selection of the different namespace via the drop-down menu) to change the selected namespace to a different namespace. The device may repeat steps 614-620 to redisplay the service graph based on the different namespace. As such, the user can quickly and efficiently monitor different microservices through the use of namespaces.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

We claim:

1. A method for displaying a service graph of microservices based at least on a namespace, the method comprising:
(a) establishing, by a device, a namespace of a plurality of namespaces for each of a plurality of microservices of one or more services;
(b) receiving, by the device, a request to display a service graph of the plurality of microservices corresponding to a selected namespace of the plurality of namespaces;
(c) generating, by the device, the service graph comprising one or more of the microservices associated with the selected namespace; and
(d) displaying, by the device, the service graph for the selected namespace.

2. The method of claim 1, wherein (a) further comprises configuring a tag of a microservice to identify one or more namespaces of the microservice.

3. The method of claim 1, wherein the namespace comprises one of a geography or a location at which a microservice is deployed.

4. The method of claim 1, wherein the namespace comprises one of a function or functionality implemented by a microservice.

5. The method of claim 1, wherein the namespace comprises an identifier for a logical groups of two or more of the plurality of microservices.

6. The method of claim 1, wherein the namespace comprises an identifier for a layer of a plurality of layers in a hierarchy of layers for the one or more services.

7. The method of claim 1, wherein (b) further comprises receiving, by the device via a user interface, a selection of the namespace from the plurality of the namespaces.

8. The method of claim 1, further comprising receiving a request to change the selected namespace to a second namespace and redisplaying the service graph based at least on the second namespace.

9. The method of claim 1, further comprising receiving a request to display the service graph with a resolution from a plurality of resolutions, wherein each of the plurality of resolutions comprises a corresponding level of detail.

10. The method of claim 9, further comprising displaying, by the device, the service graph based at least on the resolution.

11. A system for displaying a service graph of microservices based at least on a namespace, the system comprising:
a device comprising one or more processors, coupled to memory, and configured to
establish a namespace of a plurality of namespaces or each of a plurality of microservices of one or more services;
receive a request to display a service graph of the plurality of microservices corresponding to a selected namespace of the plurality of namespaces;
generate the service graph comprising one or more of the microservices associated with the selected namespace; and
display the service graph for the selected namespace.

12. The system of claim 11, wherein a tag of a microservice is configured to identify one or more namespaces of the microservice.

13. The system of claim 11, wherein the namespace comprises one of a geography or a location at which a microservice is deployed.

14. The system of claim 11, wherein the namespace comprises one of a function or functionality implemented by a microservice.

15. The system of claim 11, wherein the namespace comprises an identifier for a logical groups of two or more of the plurality of microservices.

16. The system of claim 11, wherein the namespace comprises an identifier for a layer of a plurality of layers in a hierarchy of layers for the one or more services.

17. The system of claim 11, wherein the device is further configured to receive, via a user interface, a selection of the namespace from the plurality of the namespaces.

18. The system of claim 11, wherein the device is further configured to receive a request to change the selected namespace to a second namespace and redisplay the service graph based at least on the second namespace.

19. The system of claim 11, wherein the device is further configured to receive a request to display the service graph with a resolution from a plurality of resolutions, wherein each of the plurality of resolutions comprises a corresponding level of detail.

20. The system of claim 19, wherein the device is further configured to display the service graph based at least on the resolution.
